(19) United States
(12) Patent Application Publication
(10) Pub. No.: US 2007/0116231 A1
(43) Pub. Date: May 24, 2007

(54) Selecting between automated and live communication channels based on current call center status

(76) Inventors: David DeGraaff, Mountain View, CA (US); Dmitri Krakovsky, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/259,736

(22) Filed: Oct. 25, 2005

(51) Int. Cl. H04M 3/42

(52) U.S. Cl. 379/212.01

(57) ABSTRACT

In various embodiments, the present invention provides methods and systems for selecting between automated and live communication channels based on current call center status. A system and method automatically selects a communication channel for establishing communication between a customer and a customer support system. A customer contact request is received from a client device of the customer. The status of a call center is determined. Based at least partially on the status of the call center, at least one selected communication channel is selected and instructions are sent to the customer to access the customer support system via the selected communication channel.

### BACKGROUND

This invention relates to systems and methods for managing customer communication channels. Businesses may maintain a variety of channels through which their customers can communicate with them, including but not limited to call centers staffed by live personnel, interactive voice response telecom systems, and websites. Customers can generally select between any of the available means to contact the business, but each of the channels of communication has inherent benefits and drawbacks from both the customer's perspective and the business's perspective. For example, some customers may prefer interacting with a company through a company's website for certain business because websites are instantly available through an Internet connection 24 hours per day. However, customers may find that more complicated matters are difficult or time consuming to adequately explain in writing and would prefer to talk to a representative of the company. At the same time, businesses may find websites to be an inexpensive, highly-scalable solution to high volume customer traffic, but websites do not afford the business the same opportunity to develop relationships with customer as live communication does. Thus, businesses may find call centers to be among their most valuable customer communication channels, but also, due to labor costs, among the most costly.

One particular challenge faced by operators of customer call centers is managing the load of calls. Call centers can experience vast fluctuations in the amount calls received over any given period. For example, the volume of customer calls may dramatically spike shortly following a special promotion of a product or other spike in product sales. Systems and methods have been developed to handle high call volume by queuing callers and providing approximate wait times when call volume exceeds available customer service representatives. However, long wait times are frustrating to customers and can lead to customer dissatisfaction with the product and/or the company. On the other hand, it is also undesirable for a call center to be operating below capacity. Although response time is fast in those circumstances, the resource is not being efficiently used. In addition, it is not practical or cost effective to handle all fluctuations in call volume by adjusting staffing levels because of the costs of hiring and training.

### SUMMARY

In various embodiments, the present invention provides methods and systems for directing customers to a communication channel based on the current status of a call center. When a customer indicates through an Internet communication a desire to contact a company or a desire to comply with a company's request that the customer make contact, the customer receives an instruction as to which communication channel to use to access the customer support system based on the current status of a call center.

In one embodiment, a customer indicates a desire to contact the company by sending an electronic request from a client device to a company system. The company system also receives information on the status of the call center. Based at least partially on the status of the call center, the company system determines at least one selected communication channel and sends instructions to access the selected communication channel or channels to the customer. Alternatively, the client device receives the call center status and determines the recommended communication channel or channels at least partially based on status of the call center.

In one variation, the request may contain information about the customer and/or the product that is-the subject of the inquiry and/or the type of task the customer wishes to accomplish. These types of information can be used in combination with information about call center status to determine to which communication channels the customer is directed. Thus, the company can more efficiently use their resources to serve the needs of their customers.

In another variation, the customer is presented with options of which communication channel to use to access a customer support system, but at least one option is associated with an incentive. In one embodiment, the incentive structure is based on the call-center status. The incentive structure can be used to influence a customer to choose to use a particular communication channel or channels over other available alternatives without mandating that the customer do so.

### BRIEF DESCRIPTION OF THE DRAWINGS

FIG. 1 is an illustration of one embodiment of system for directing a customer to a communication channel based on call center status.

FIG. 2 is a flow chart of one embodiment of a method for instructing a customer to use a selected communication channel based on call center status.

FIG. 3 is a flow chart of one embodiment of a method for instructing a customer to use a selected communication channel based on call center status in the context of a computer product registration example.

FIG. 4 is one embodiment of a method for instructing a customer to use a selected communication channel based on call center status in the context of product sales.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

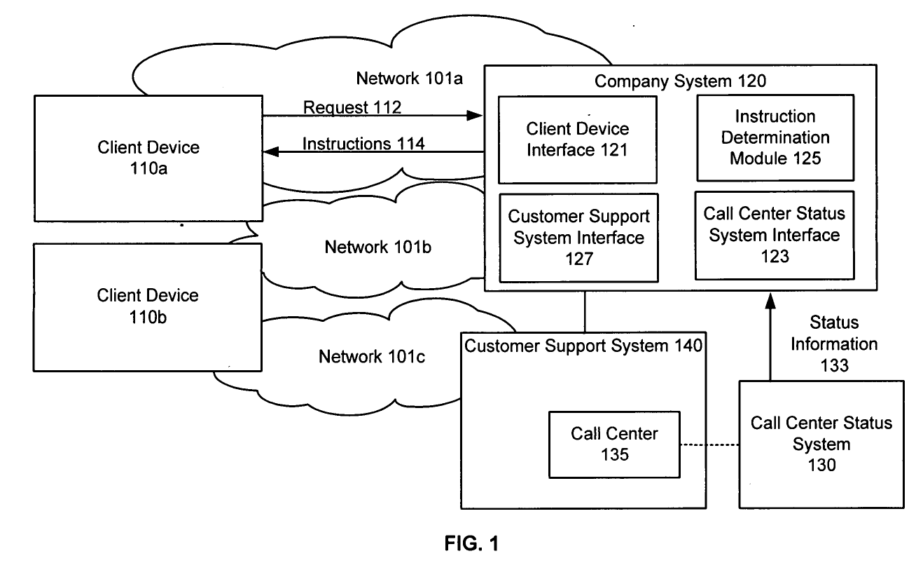

FIG. 1 shows one embodiment of a system 100 for directing a customer to a communication channel based on call center status. The system comprises client devices 110, a company system 120, a call center status system 130, and a customer support system 140. The client device 110a can be a computer, a cell phone, a personal digital assistant (PDA) or any other electronic device capable of communicatively coupling to a network 101a. Network 101 a can be any network, such as the Internet, a LAN, a MAN, a WAN, a wired or wireless network, a private network, or a virtual private network. Company system 120 is also communicatively coupled to the network 101a. Network 101a thus enables a transfer of information between the client device 110a and the company system 120. A customer may have access to a variety of client devices 110. Each client device 110 is communicatively coupled to at least one network 101. Each network 101 enables a transfer of information between a client device 110 and the company system 120 and/or the customer support system 140. The company system 120 is coupled to the customer support system 140. Thus, each network 101 is a communication channel between a client device 110 and the customer support system 140.

Company system 120 comprises a client device interface 121, a call center status system interface 123, and an instruction determination module 125, and a customer support system interface 127. The client device interface 121 could be a company-hosted webpage, an email processing center, a server, or any other interface for communicating between company system 120 and client device 110. The client device interface 121 is one example of a means for electronically receiving a customer contact request from a client device over a communication channel. The call center status system interface 123 is the interface for receiving status information 133 from the call center status system 130. The instruction determination module 125 comprises the logic for determining a preferred communication channel to convey to the client device at least partially based on the call center status, and is one example of a means for determining a selected communication channel from a plurality of communication channels. The customer support system interface 127 is an interface between the company system 120 and the customer support system 140 that enables the customer support system 140 to access resources on the company system 120, including for example, data or information sources, such as a customer database, a product database, product manuals, company files, or other resources.

The system 100 also includes a call center status system 130. The call center status system 130 monitors the call center 135 to determine the status of the call center, and is one example of a means for determining call center status. In one embodiment, the call center status system 130 comprises Avaya Call Management System, a call center monitoring system available for retail purchase from Avaya Inc. headquartered in Basking Ridge, N.J. Alternatively, any other call center monitoring system could also be used to monitor call center 135 to determine the call center status. In one embodiment, the call center status system 130 is not directly connected to the call center 135. For example, the call center status system 130 may receive information on the status of the call center through an application that receives information on the status of the call center from a human call center agent who observes the call center load or wait time. In one embodiment, the call center status system 130 is coupled to the call center status system interface 123 of the company system 120 via a network 101. Alternatively, the call center status system 130 is directly connected to or is a part of the company system 120.

The system 100 also includes a customer support system 140. The customer can use client devices 110 to access the customer support system 140 via a plurality of communication channels to accomplish a variety of tasks. The customer support system 140 can include, for example, a variety of data sources, resources, and modules for technical assistance, product registration, product sales, product information, and/or any other customer support modules. The customer support system 140 can also include the call center 135. The customer support system 140 is connected to the company system 120 via the customer support system interface 127. As described above, the customer support system interface 127 enables the customer support system 140 to access resources on the company system 120, including for example, data or information sources, such as a customer database, a product database, product manuals, company files, or other resources.

As shown in FIG. 1, client device 110 sends a request 112 over a network 101a to the company system 120 via the client device interface 121. In one embodiment, the request 112 comprises information specifying the type of task a user of the client device 110a desires to accomplish. In one variation, the request comprises information about the user and/or information about the user's relationship to the company such as information indicating the user had purchased a product from the company or was interested in a product available from the company. The request 112 is received by the company system 120 through the client device interface 121. The company system 120 also receives status information 133 from the call center status system 130 regarding the status of call center 135. In one embodiment, at the basic level, that status information indicates whether the call center is open and operational. In one embodiment, the status information comprises the call volume load experienced by the call center. In another embodiment, the status information comprises the current average wait time. The status information may also include other information about the staffing levels or information about call center staff such as fields of specialization, performance records, or the like. The instruction determination module 125 uses the status information 133 to determine which of the available communication channels is recommended and generates instructions 114 for accessing the customer support system 140 via the recommended communication channel or channels. The company system 120 sends instructions 114 over the network 101a to the client device 110a using the client device interface 121. In one embodiment, the instructions 114 enable the client device 110a to access the customer support system 140 via a communication channel. Alternatively, the instructions 114 can enable the user operating the client device 110a to access the customer support system 140 via a communication channel using another client device 110b. For example, instructions 114 can comprise a phone number to access call center 135, a phone number to access an IVR system, or a link to the company's customer service web page.

In another embodiment, the instruction determination module 125 resides in the client device 110. In this arrangement, the status information 133 is received at the client device, for example, from the call center status system 130 via the client device interface 121 of the company system 120. Thus, the client device interface 121 is one example of a means for transmitting the call center status to the client device. In one implementation, the company system 120 can send the status information 133 to the client device in response to the request 112. In this embodiment, the instruction determination module 125 within the client device 110 can use the status information 133 to determine which of the available communication channels is recommended. The instruction determination module 125 can generate instructions enabling the client device 110 to access another communication channel or enable the user operating the client device 110 to access another communication channel, for example, by using another client device 110.

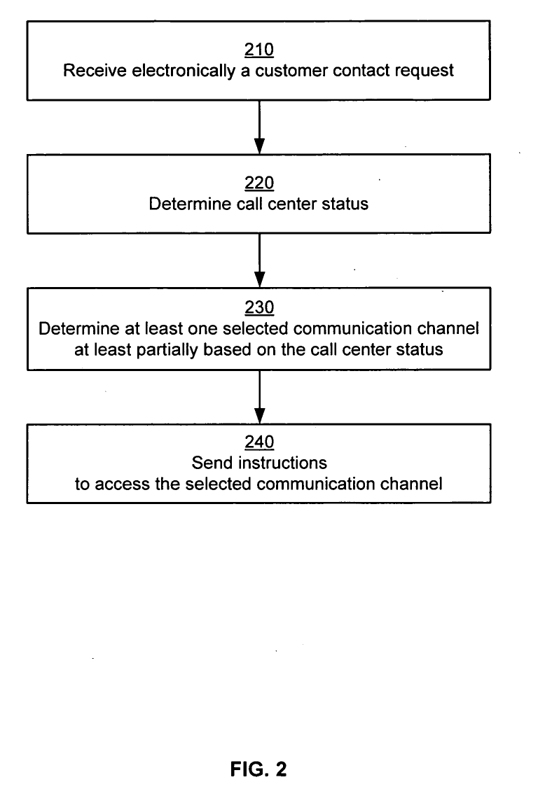

FIG. 2 is a flow chart of one embodiment of a method 200 for instructing a customer to use a selected communication channel based on call center status. First, a customer contact request is electronically received 210 over a communication channel. In one embodiment, the customer contact request comprises a hit at a web page. Alternatively, the customer contact request can comprise an email or direct interface with the client product. In one embodiment, the contact request comprises information identifying the customer. In another embodiment, the contact request also comprises information about the customer and/or the product that is the subject of the inquiry and/or the type of task the customer wishes to accomplish.

In step 220 of the method 200, call center status is determined. In one implementation, call center status is updated by the call center status system 130 in real time or, alternatively, at preset intervals. In another implementation, the company system 120 polls the call center status system 130 for the status information 133 as needed, for example, in response to the receipt of a request 112.

In step 230, at least one selected communication channel is determined at least partially based on the call center status. The determination can also be based on other factors, such as information about the customer and/or the product that is the subject of the inquiry and/or the type of task the customer wishes to accomplish.

In step 240, instructions to access the selected communication channel are sent. For example, these instructions 114 can include a phone number to access a call center, a phone number to access an IVR system, a link to a web page, an email address, or any other instructions to a user directing a user to at least one communication channel. In one implementation, the instructions 114 comprise instructions enabling access to more than one communication channel and the user is given a choice among these communication channels. In one embodiment, the instructions 114 comprise the approximate wait time for accessing the call center. In one embodiment, the instructions 114 are displayed to the user, for example on the client device 110. In another embodiment, the instructions 114 are received by an application on the client device 110 and the application automatically implements those instructions. For example, the application can open a web browser to access the webpage at the Internet address specified in the instructions 114 or the application can open an email client to generate a new email message to the email address specified in the instructions 114.

In an alternative embodiment, an indication of call center status is received at the client device 110, and the determination of step 230 is made at the client device 110. Thus, instructions to access the selected communication channels are already present on the client device 110. The client device can display the instructions and/or an indication of the selected communication channels and/or automatically connect to the customer support system 140 using a selected communication channel.

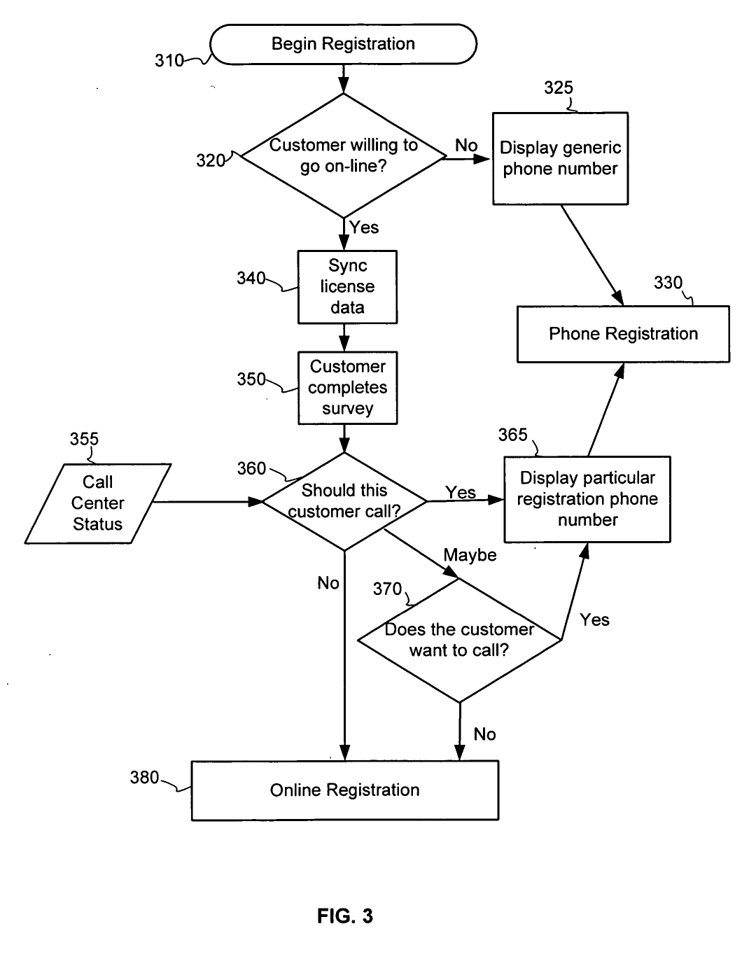

FIG. 3 is a flow chart of one embodiment of a method 300 for instructing a customer to use a selected communication channel based on call center status in the context of a computer product registration example. The present invention can be used in many other contexts such as in sales of products and/or services and customer technical assistance, for example, without departing from the teachings of the invention disclosed herein.

The method 300 begins when a customer desires to begin registration 310. For example, when software is accessed on a customer's computer system for the first time, the customer is asked to register the product. If the customer selects to begin registration 310, in one implementation, the customer is then asked if the customer is willing to go online 320. In another implementation, the application automatically attempts to connect to the company system.

If the customer is not willing to go on-line or if the attempt to connect to the company system fail, a generic phone number is displayed 325. For example, this may be the contact information for the main customer service center. The customer can use this number to complete the product registration over the phone 330. In one implementation, the generic phone number connects the customer to an IVR system. Alternatively, the generic phone number connects the customer to the call center 135 for product registration.

If the customer is willing to go on-line, the license data is synced 340 with the company system 120. For example, the client device can automatically send the product license number to the company system to be checked against company records. In one implementation, the results of this check are used as one factor in determining the communication channel to which the customer is directed. In this example, if the product has not been registered before, the customer may be asked to call. If the product has been registered before, the customer may be sent to an online re-registration webpage. If the product has been registered more than a designated number of times, the customer may be directed to call to explain. In another embodiment, step 340 is omitted from the method 300.

In this embodiment, the customer completes a survey 350 and the survey results are transmitted to the company system 120. Although the company system 120 already has the license data from step 340, the survey can prompt the customer to supply any other information the company wants or that may be deemed useful to the determination of which communication channel to direct the customer. For example, if the customer answers a survey question that indicates the customer is a new user of a product rather than an old customer who has purchased a product upgrade, the company may want the customer to register the product over the phone so that the company has the opportunity to more personally address any other concerns the new customer may have. As another example, if a customer answers a survey question that indicates the customer may qualify for a discount or special promotion, the company may want the customer to register the product over the phone so that a customer service representative can fully explain the details of the offer and immediately answer the customer's questions. As yet another example, if a customer's survey responses indicate a high degree of familiarity with the product and no outstanding concerns that could be better addressed through a live communication channel, the company may want the customer to use an automated communication channel so that call center is not unnecessarily burdened. In this embodiment, a combination of customer information and the call center status is used to determine if a customer should call. In an alternative embodiment, customer information is not used to determine if the customer should call.

In this embodiment, if, based on the call center status and the customer survey responses, it is determined in step 360 that the customer should call, a particular registration phone number is displayed 365 to the customer. The customer uses that phone number to complete a phone registration 330.

If, based on the call center status and the customer survey responses, it is determined in step 360 that the customer should not call, the customer is directed to an online product registration form where the customer can complete an online registration 380.

If, based on the call center status and customer survey responses, it is determined in step 360 that it is unclear whether the customer should or should not call, or if the customer maybe should call, the customer can be given a choice as to whether to call in step 370. In one implementation, the customer is provided the current average wait time for the call center to help the customer decide whether to complete a phone registration or an online registration. If the customer wants to call, a particular registration phone number is displayed 365 to the customer. The customer uses that phone number to complete a phone registration 330. If the customer does not want to call, the customer is directed to an online product registration form where the customer can complete an online registration 380.

In the embodiment shown in FIG. 3, both the customer survey answers from step 350 and the call center status 355 are used to determine if the customer should call 360. This determination can be made using preset business rules that relate call volume experienced by the call center to categories of customers who should be encouraged to call. One example of a set of these business rules is given in the table below.

| Call Center Status | Determination |
|---|---|
| High Call Volume | Direct all customers to online form |
| Medium Call Volume | Provide customers the option of online form |
| | or call center |
| Low Call Volume | Direct all customers to call center |

As shown in this example, no distinction is made between customers based on customer information. If the call center is experiencing a high call volume or a long average wait time to talk to a company representative, all additional customers are directed to an online form to complete product registration. If the call center is experiencing a medium amount of calls, the customers are given the option of online form or the call center. This situation corresponds to the “maybe” determination of whether the customer should call in step 360. If the call center is experiencing low call volume, in this example, all customers are directed to the call center.

Another example of a set of business rules governing the determination that would be made in step 360 is given the table below.

| Call Center Status | Determination |
|---|---|
| High Call Volume | Only highest priority customers are directed |
| | to call center; all others to online form |
| Low Call Volume | High and medium priority customers are |
| | directed to call center; all others to online |
| | form |

In this example, customers are divided into priority groups based on information about the customer and/or the product. In this example, if the call center is experiencing high call volume, only the highest priority customers are directed to the call center and all others are directed to an online registration form. If the call center is experiencing low call volume, in this example, the high and medium priority customers are directed to the call center and all others are directed to an online registration form.

Alternative embodiments to the above examples of business rules, with more gradations of status and more or different determinations as to which communication channels to direct customers at each of those statuses, are also possible.

In one variation, it may be desirable to offer customers a choice of communication channels to use to accomplish a task. However, a company may prefer a particular customer, a group of customers, or all customers to use a particular communication channel even when a choice among communication channels is offered. In such circumstances, that customer or those customers can be given the option to select among available communication channels, but at least one of the options is associated with an incentive for using that communication channel. For example, a customer may be given the option of choosing the call center or online registration, but if the customer calls the call center to register, the customer will receive a free gift that is not available to those who register online. In one implementation, the amount of the incentive offered to the customer can be increased as the length of the waiting time to access the call center increases. For example, it may be that a company values the chance to talk to customers with particular characteristics even if the call center is already experiencing a high call volume that corresponds to a long wait time. In this situation, if the wait time is under 90 seconds, a small gift may be offered to these customers in exchange for calling. If the wait time exceeds 90 seconds, an additional small gift or a larger gift may be offered to encourage the customer to call despite the wait time. One example of a free gift offer that could be displayed to customers is “Free 60 days of customer support included only if you call to register.” As wait times increase over some threshold, the length of the free support period offered could also increase. In one embodiment, the incentive is advertised a limited time offer that includes an expiration time, e.g., “ . . . only if you call to register in the next 10 minutes.”

The above example described the present invention in the context of a computer product registration example. The present invention is also useful in other contexts, such as product and service sales and customer technical support across any industry where multiple communication channels are available.

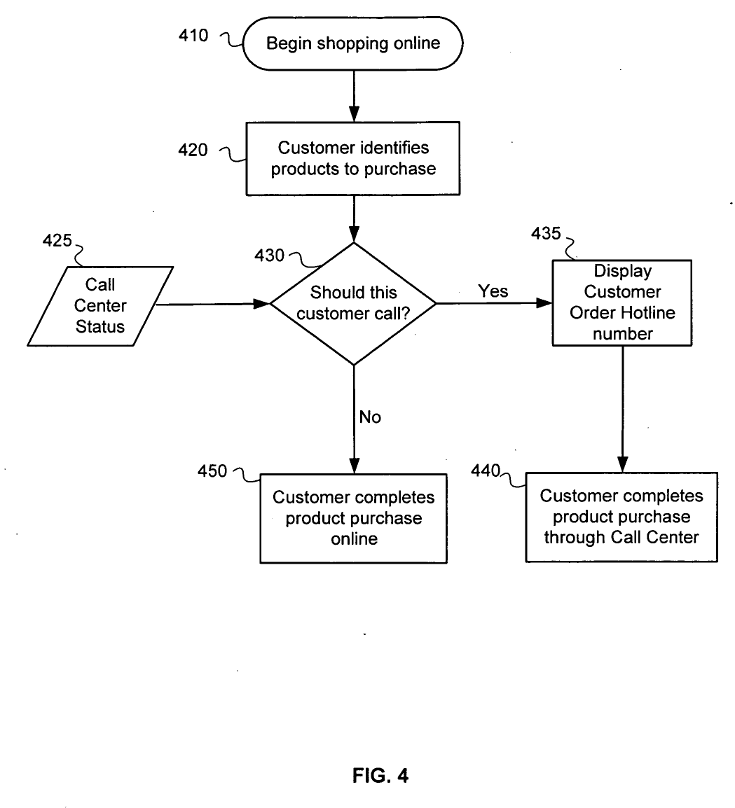

FIG. 4 is one embodiment of a method 400 for instructing a customer to use a selected communication channel based on call center status in the context of product sales. In this example, a company may maintain both a website and a call center to receive customer orders. A customer may begin shopping online 410 by using a company's website to gather information and compare products. The customer identifies the products to purchase 420, and selects a “Buy Now” button or similarly indicates a desire to execute a purchase. The company system receives information about the call center status 425 and the information identifying the products the customer has identified to purchase. In this example, the company system 120 uses the call center status information along with the product information to determine whether this customer should call to execute the order rather than executing the order online. There may be many reasons a company would prefer customers who identify certain products for purchase to call to execute the order. For example, the company may wish to personally verify that the product is the best fit for the customer's needs or may wish to offer additional compatible products for sale. In one variation, it is the quantity of the product identified for purchase that triggers the company's desire to speak with the customer. Regardless of how these customers are identified, business rules can be established such that if the call center is too busy, these customers are also instructed to complete their orders online. This prevents these customers from experiencing the frustration of long wait times which may result in the customers giving up and/or ordering from a competitor.

If, in step 430, it is determined that this customer should call, a customer order hotline number is displayed 435. The customer uses this number to complete the product purchase through the call center 440. If, in step 430, it is determined that this customer should not call, the customer completes the product purchase online.

The present invention has been described in particular detail with respect to two possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method of instructing customers to access a customer support system via selected communications channels based on call center status comprising:
electronically receiving a customer contact request from a client device over a first communication channel;
determining call center status; and
determining at least one selected communication channel from a plurality of communication channels at least partially based on the call center status.

2. The method of claim 1, wherein the call center status is transmitted to the client device and the determining at least one selected communication channel occurs at the client device.

3. The method of claim 1, wherein determining call center status and determining at least one selected communication channel occur at a device remote from the client device.

4. The method of claim 1, further comprising sending instructions to the client device to access the customer support system via the selected communication channels.

5. The method of claim 1, wherein the customer contact request comprises at least one selected from a group consisting of customer information, product information, and type of request.

6. The method of claim 5, wherein determining at least one selected communication channel from a plurality of communication channels is at least partially based on the customer contact request.

7. The method of claim 1, wherein the call center status comprises an average wait time.

8. The method of claim 1, wherein the call center status comprises a call center call volume load.

9. The method of claim 1, wherein the plurality of communication channels comprises a call center and a website.

10. The method of claim 1, wherein at least one of the selected communication channels is associated with an incentive for using that communication channel and the instructions sent to the client device comprise information identifying the selected communication channel and associated incentive.

11. A system for instructing customers to access a customer support system via selected communications channels based on call center status comprising:
a network,
a client device for sending a customer contact request via the network; and
a company system comprising a call center status system interface for determining call center status, an instruction determination module for determining at least one selected communication channel from a plurality of communication channels at least partially based on the call center status, and a client device interface for receiving the customer contact request and sending instructions to the client device via the network to access the customer support system via the selected communication channels.

12. The system of claim 11, wherein the customer contact request comprises at least one selected from a group consisting of customer information, product information, and type of request.

13. The system of claim 11, wherein the instruction determination module determines at least one selected communication channel from a plurality of communication channels at least partially based on the customer contact request.

14. A system for instructing customers to access a customer support system via selected communications channels based on call center status comprising:
a network,
a client device for sending a customer contact request via the network; and
a company system for receiving the customer contact request, the company system comprising a call center status system interface for determining call center status and a client device interface for transmitting the call center status to the client device,
wherein the client device determines at least one selected communication channel from a plurality of communication channels at least partially based on the call center status.

15. The system of claim 14, wherein the customer contact request comprises at least one selected from a group consisting of customer information, product information, and type of request.

16. The system of claim 14, wherein the client device determines at least one selected communication channel from a plurality of communication channels at least partially based on the customer contact request.

17. A computer program product for instructing customers to access a customer support system via selected communications channels based on call center status, the computer program product stored on a computer readable medium, and adapted to perform the operations of:
electronically receiving a customer contact request from a client device over a first communication channel;
determining call center status; and
determining at least one selected communication channel from a plurality of communication channels at least partially based on the call center status.

18. The computer program product of claim 17, further adapted to perform the operation of transmitting the call center status to the client device.

19. A system for instructing customers to access a customer support system via selected communications channels based on call center status comprising:
means for electronically receiving a customer contact request from a client device over a first communication channel;
means for determining call center status; and
means for determining at least one selected communication channel from a plurality of communication channels at least partially based on the call center status.

20. The system of claim 19, further comprising means for transmitting the call center status to the client device.
